(19) United States
(12) Patent Application Publication
(10) Pub. No.: US 2015/0138089 A1
(43) Pub. Date: May 21, 2015

(54) INPUT DEVICES AND METHODS

(71) Applicant: TabiTop, LLC, Salt Lake City, UT (US)

(72) Inventors: Spencer Angerbauer, Salt Lake City, UT (US); David Riskin, Salt Lake City, UT (US); Severin Sorensen, Salt Lake City, UT (US); Phong Le, Salt Lake City, UT (US)

(21) Appl. No.: 14/539,451

(22) Filed: Nov. 12, 2014

Related U.S. Application Data
(60) Provisional application No. 62/011,153, filed on Jun. 12, 2014.
(60) Provisional application No. 61/905,037, filed on Nov. 15, 2013.

(51) Int. Cl. G06F 3/01; G06F 3/033; G06F 3/0346; G06F 3/041

(52) U.S. Cl. CPC G06F 3/017; G06F 3/041; G06F 3/033; G06F 3/0346
USPC 345/158; 345/156; 345/173; 345/157

(57) ABSTRACT

Devices and methods for providing an interface to a computing device are disclosed herein. The disclosed embodiments allow a user to utilize a first computing device, such as a smartphone or other mobile computing device, as a mouse-like peripheral input device for an associated second computing device, such as a tablet computing device. A user can utilize the first computing device as a fully functional touchpad, movement, and/or accelerometer mouse input device. Manipulation of the first computing device is translated into mouse control inputs and movements to be displayed on the associated second computing device. The first computing device may be manipulated in order to fully control movements, gestures, and various touch inputs as well as click inputs on a display, and functionality of applications executing on the second computing device.

### RELATED APPLICATIONS

This application claims the benefit under 35 U.S.C. §119(e) of U.S. Provisional Application No. 62/011,153, entitled INPUT SYSTEMS, DEVICES AND METHODS, filed Jun. 12, 2014, and U.S. Provisional Application No. 61/905,037, entitled VIRTUALIZATION SYSTEMS AND METHODS, filed Nov. 15, 2013, each of which is incorporated by reference herein in its entirety.

### COPYRIGHT NOTICE

© 2014 Tabitop, LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The present disclosure is directed generally to interfacing with a computing device, and more particularly to systems, devices, and methods for providing input to a computing device.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a system for providing input to a computing device, according to one embodiment;

FIG. 2 is a schematic diagram illustrating an input computing device, according to one embodiment;

FIG. 3 is a schematic diagram illustrating a receiving computing device, according to one embodiment;

FIG. 4 is a flow diagram of a method of providing input to a computing device, according to one embodiment, and illustrates interaction between a receiving device and an input device;

FIG. 5A is a schematic diagram representing existing systems for providing mouse gesture input to a computing device;

FIG. 5B is a schematic diagram representing a system for providing mouse input to a computing device, according to one embodiment;

FIG. 5C is a schematic diagram representing a system for providing mouse input to a computing device, according to another embodiment;

FIG. 6 illustrates example user inputs used to indicate a mouse gesture for an embodiment of the present disclosure that includes a touchpad;

FIG. 7 illustrates a touchpad version user interface for a smartphone application, according to one embodiment;

FIG. 8 illustrates a user interface of an input computing device presenting a settings screen used to find and connect to a receiving computing device;

FIG. 9 illustrates wireless connection and interactivity between an input device and a receiving device, according to one embodiment;

FIG. 10 illustrates how an input device may connect to a receiving device, according to one embodiment; and

FIG. 11 is a flow diagram of a method of providing input via an input computing device to a receiving computing device according to one embodiment.

### DETAILED DESCRIPTION OF PREFERRED EMBODIMENTS

The present disclosure is directed to devices and methods for providing input to a computing device. According to one embodiment, technologies (e.g., Bluetooth and local area wireless (Wi-Fi) technologies) and hardware components of an input computing device (e.g., a smartphone device or other portable computing device) are utilized to establish communication directly between the input computing device and a receiving computing device (e.g., a tablet device, laptop, or desktop) such that manipulations of the input computing device provide input to the receiving computing device. For example, the disclosed embodiments allow a user to connect a smartphone device to a tablet device (e.g., through Bluetooth and/or wireless technology) and then use the smartphone device to control the tablet device by manipulating a pointer and inputting movements, strokes, and other input gestures commonly provided by traditional hardware mouse devices or similar peripheral hardware devices. More specifically, the disclosed embodiments allow a smartphone device to connect to and interact with a tablet computing device as a fully functional touchpad-based, movement-based, and/or accelerometer-based (e.g., gyro-based) mouse input device. The disclosed embodiments are particularly advantageous to provide input to tablets and other computing devices that may traditionally be provided using a hardware mouse device or similar hardware peripherals, whether or not the other computing devices allow hardware-based mouse device connections.

Since the widespread growth of tablet computing devices (“Tablets”) within the marketplace, many manufacturers, developers, software engineers, and applications have sought to adopt technologies designed to allow user interface through interaction with a touchscreen on the Tablet device. Although touchscreen interaction has become the standard for many applications to interact with users, most Tablet users also continue to utilize a separate desktop or laptop-based personal computer (“PC”) in order to complete daily routine tasks such as creating content. The inventors have observed that, in reality, most Tablets have been designed to be a heavy content consumption device, whereas desktops and laptops continue to exist and be preferred by users as a content creation device.

One reason Tablets are not heavily used as content creation devices is a lack of input peripherals. Manipulating a touchscreen can be, at times, laborious, especially in tasks involving content creation. When a user uses a touchscreen for providing input, greater movement is needed than may be customary using other input devices, such as a hardware mouse device or similar hardware input peripheral. The greater movement, and thus a resulting challenge, is because the touchscreen occupies a larger area than the area of typical mouse movements. Because much of the input used for creation employs much more screen area and movement than the compared utilization of a mouse device, many Tablets have been used more as consumption devices, rather than as creation devices.

Some of the differences between Tablets and laptops and/or desktops can become quite apparent to users during routine interface interaction. Some of these differences may arise based on ability to connect and use a mouse device. Users who are generating content quickly notice differences in ease of creating content on a desktop or laptop as compared to a Tablet, mainly because a separate mouse device can create conveniences for generating content. Content creators and other users quickly note a loss of convenience and ease of use when a hardware mouse device is not available. Typically a hardware mouse peripheral is not used in conjunction with a Tablet. One reason is that Tablets generally do not include ports that accept input peripherals such as a hardware mouse. Another reason is that the various manufacturers impose limitations that restrict connection of a dedicated hardware mouse peripheral. These limitations have impaired the ability of hardware mouse manufacturers to design devices that can seamlessly connect to various Tablet devices and the corresponding operating systems. As a result, many Tablet devices, specifically iOS, Android, and Windows Mobile based Tablets, have limited mouse functionality due to the limitations of both available hardware and software devices. There simply is a lack of an input mechanism designed to emulate and simulate a true mouse input experience on a Tablet.

Conversely, content consumers notice differences between Tablet devices and laptop computers (and desktop computers) in portability and ease of consuming content on such devices. Tablet devices are generally lighter and/or smaller and include interfaces designed for consuming content.

Because of the varying, and presently very different, advantages, many users feel compelled to travel with both a Tablet and a laptop, and many users feel compelled to maintain as operational both a Tablet and a laptop and/or desktop computer. These users maintain and utilize a Tablet for consuming content, particularly when traveling, for the portability and ease of consuming content on a Tablet. These users maintain and utilize a laptop and/or desktop to perform content creation functions (e.g., using word processor applications, spreadsheet applications, etc.), which simply cannot presently be performed easily on a Tablet.

The present inventors recognize the desirability of providing mouse gestures as input for creating content on a Tablet to combine such convenience with the ease of transporting Tablets and consuming content on a Tablet.

Often, users of Tablets also carry a smartphone device (e.g., in a pocket) or otherwise have a smartphone device close by, even when utilizing a Tablet. The disclosed embodiments enable a smartphone device to function as a fully featured, connected mouse gesture input device that provides input similar to, or interpretable to provide input similar to, a hardware mouse device.

Presently there are no other applications designed to work on multiple operating systems and devices to communicate wireless mouse input signals, movements, gestures, and/or inputs. There may be a desire to enable mouse gesture input on a Tablet.

The present disclosure provides embodiments for connecting an input computing device (e.g., a smartphone running, for example, an iPhone, Android, or Windows based mobile operating system) through Bluetooth and/or Wi-Fi technology to interact directly with a receiving computing device (e.g., a Tablet, such as an iPad®, Galaxy®, or Surface®) and emulate a touchpad input peripheral through the input computing device (smartphone) to the receiving computing device (Tablet), thus creating a “mouse” experience for users. The disclosed embodiments may provide common mouse gestures, including inputs, movement gestures, controls, and/or features traditionally provided through hardware mouse device movement and interaction, which include, but are not limited to, the following interactive elements enabled and/or implemented by the input computing device and the receiving computing device:
Mouse Pointer Movement (Up, Down, Left, Right, and Angled, Straight, and Circular movements of all kinds). This includes movement of a mouse pointer (e.g., a pointed arrow or similar icon) representing traditional mouse movement.
Scroll Features (Up, Down, Left, Right, and Angled scrolling movements of all kinds). This includes the scrolling movement of a pointed arrow, or similar icon representing traditional mouse scrolling movement, typically in an area with a scroll bar input or additional text/content located off the currently viewed screen.
Point and Click (Left, Right, Double, Drag-and-Drop Click interactions). This includes the interaction of the various click inputs commonly found and used with traditional mouse inputs.
Swipe Elements (two-finger, three-finger, and four-finger swipe interactions). This includes trackpad-based mouse movements used for switching screens, applications, and other elements commonly found within trackpad mouse input features.

The disclosed embodiments can enable a smartphone or similar computing device to be used as a common input device (e.g., in the same manner as a hardware mouse input device) for a Tablet. This better enables utilization of a Tablet device as a creation device through the use of scalable movements, gestures, and inputs. Much like a traditional hardware mouse input device, the disclosed embodiments may utilize a multiple ratio for translating movement to input. For example, when a user moves a finger across a touchscreen of the input computing device (e.g., smartphone), the movement of the finger may be translated into a 1:2 (or greater) ratio movement on the receiving computing device (e.g., Tablet). More specifically, when a user moves a finger one pixel across the input device, the mouse icon/graphic (e.g., mouse pointer) displayed on the receiving device may be moved two pixels or more, thus enhancing the usability and scalability of movement input.

The disclosed embodiments may enable any type of receiving computing device to receive mouse-based inputs and commands, thus giving content creation users another alternate input device for entering and creating data. For example, Tablet users would have another input device besides the touchscreen for entering and creating data. For more complex processes of a Tablet device, such as spreadsheets and other applications that may require a “dragging” or “movement” effect of a mouse pointer, the disclosed embodiments enable mouse gestures that provide such effect.

In one embodiment, a user interface of an input computing device (e.g., smartphone) may provide a screen that allows a user to see available receiving computing devices (e.g., Tablets) to which the input computing device may connect to provide mouse gestures as input. Similarly, a user interface of a receiving computing device may provide a screen that allows a user to see available input computing devices that may connect to provide mouse gestures to the receiving computing device. Assuming a compatible device is detected, a representation of the compatible device is shown on the screen with an option to connect. Once permissions have been established for both devices, the two devices can interact with each other, and the input computing device can send input signals that include mouse gestures to the receiving computing device.

In other embodiments, the receiving device may be a desktop computing device, a server computing device, or the like. In still other embodiments, the receiving device may be simply another computing device (e.g., a computing device integrated with an automobile, a vending machine (Redbox®), or a television), or any computing device having a processor and appropriate technology and hardware components to enable communication with and receipt of mouse gestures from an input computing device.

An input computing device, according to one embodiment of the present disclosure, may include an input module to receive user inputs that indicate a mouse gesture that is intended to perform an action within an application on a receiving computing device. The input module may include an input application (e.g., a software application “app” technology), which may be implemented and/or executed in one or more of a variety of input computing devices (e.g., smartphone and/or handheld portable devices).

The receiving computing device, according to one embodiment of the present disclosure, may include a receiver module to receive input indicating a mouse gesture intended to perform an action within an application executing on the receiving computing device. The receiver module may include a receiving application (e.g., a software application “app” technology), which may be implemented and/or executed in one or more of a variety of receiving computing devices (e.g., a Tablet or other computing device).

These two applications, the input application and the receiving application, may communicate together to create a simulated experience of a mouse-to-desktop (e.g., of a personal computer) interaction. The disclosed embodiments may function with or be implemented on a myriad of smartphones and Tablet devices, such as an iPhone, Android, and Windows Mobile Phone, and may allow users to use a smartphone or other portable device as a wireless mouse control for a secondary device, such as a Tablet (e.g., an iPad, Android Tablet, or Microsoft Surface), laptop, or desktop.

The following detailed description is not intended to limit the scope or capabilities of the disclosure to the sample representations, but instead to enable a person skilled in the art to design, program, and utilize the disclosed technology.

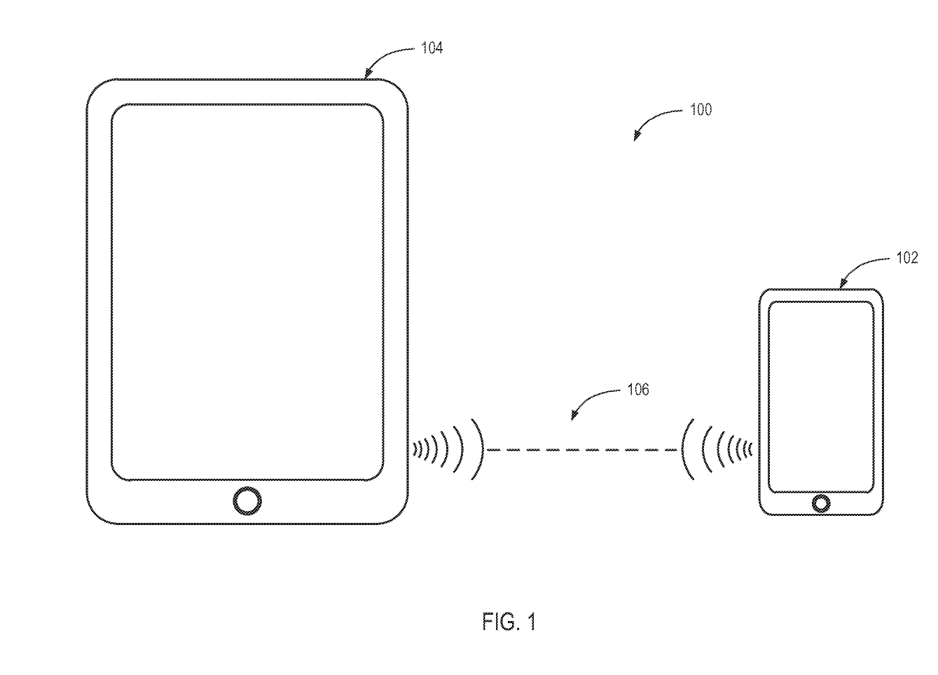

FIG. 1 illustrates a system 100 for providing input to a computing device, according to one embodiment. The system 100 includes an input computing device 102 and a receiving computing device 104. The input computing device 102 is wirelessly linked to the receiving computing device 104 via a wireless communication interface and/or protocol, such as Bluetooth, Wi-Fi, or the like. A direct wireless communication link 106 is established between the input computing device 102 and the receiving computing device 104 that enables manipulations of the input computing device 102 to provide input to the receiving computing device 104. The system 100 enables a user to provide mouse gestures as input to the receiving computing device 104 using the input computing device 102.

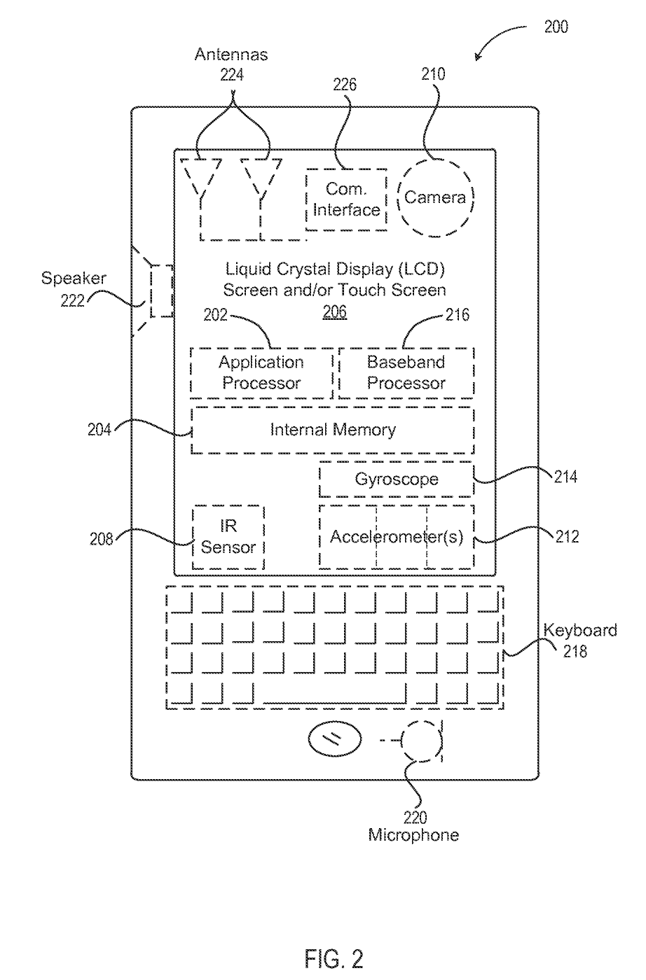

The input computing device 102 may be a portable computing device, such as a smartphone. The input computing device 102 may be an independent computing device capable of receiving input from a user, such as via a touchscreen, and executing user applications and/or performing various functions. The input computing device 102 includes a touchscreen, a wireless communication interface for directly communicating with other computing devices such as the receiving computing device 104, and telephony hardware for connecting to a wireless telephone communication network. In other embodiments, the input computing device 102 may be a smart device such as an Apple® iTouch®, without telephone capabilities. In still other embodiments, the input computing device 102 may be a Tablet. An input computing device, such as the input computing device 102 of FIG. 1, is discussed below in greater detail with reference to FIG. 2.

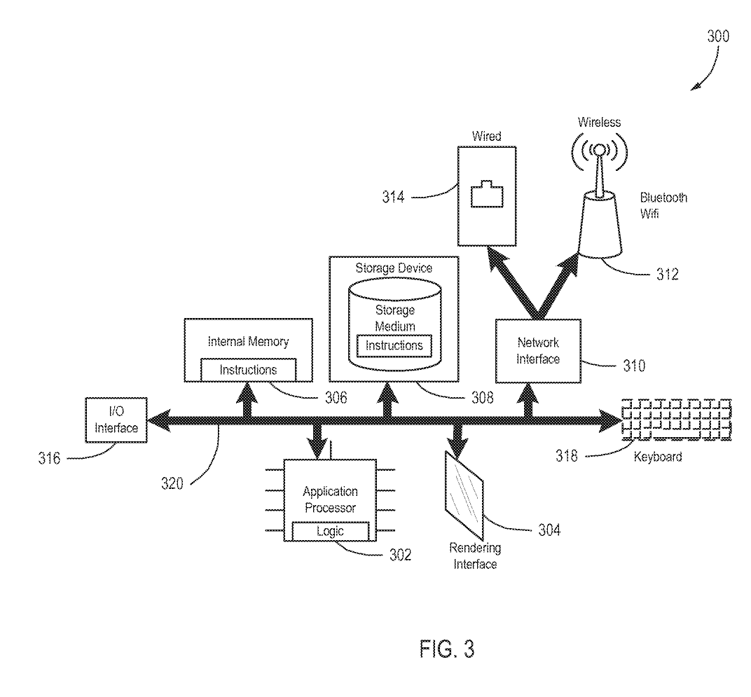

The receiving computing device 104 may be any computing device capable of executing user applications that may accept mouse gestures as input. For example, the receiving computing device 104 of the illustrated embodiment of FIG. 1 is a Tablet. The receiving computing device 104 is a computing device capable of receiving input from a user and executing user applications and/or performing various functions. The receiving computing device 104 includes a touch screen and a wireless communication interface for directly communicating with other computing devices such as the input computing device 102. The receiving computing device 104 may lack ports for connecting input peripherals, and in particular a hardware mouse input device. In other embodiments, the receiving computing device 104 may be a smartphone. In still other embodiments, the receiving computing device 104 may be a laptop computer. In still other embodiments, the receiving computing device 104 may be a desktop computer. In still other embodiments, the receiving computing device 104 may be a server computer. A receiving computing device, such as the receiving computing device 104 of FIG. 1, is discussed below in greater detail with reference to FIG. 3.

The wireless communication link 106 between the devices 102, 104 may be established via Bluetooth®, Wi-Fi®, or similar wireless communication technology. The input computing device 102 and the receiving computing device 104 may include a wireless communication interface to enable establishment of the link 106.

FIG. 2 is a schematic diagram illustrating an input computing device 200, according to one embodiment. The input computing device 200 may be used as the input computing device 102 of FIG. 1. In FIG. 2, the input computing device 200 is a smartphone. The input computing device 200 includes an application processor 202, internal memory 204, a rendering interface (e.g., liquid crystal display (LCD) screen) and/or touchscreen 206, an infrared sensor 208, a camera 210 or other imager, one or more accelerometers 212, a gyroscope 214, a baseband processor 216, a keyboard 218, a microphone 220, a speaker 222, one or more antennas 224, and a communication interface 226. As can be appreciated, the input computing device 200 may include other common components that may not be shown, such as a battery or other power supply, GPS, dedicated graphics processing unit (GPU), light/flash, non-volatile memory port, and the like, which are known in the art. The input computing device 200 includes an input module, which may include one or more of the touchscreen 206, the infrared sensor 208, the camera 210, the accelerometers 212, and/or the gyroscope 214, which enable input to the input computing device 200 indicating a mouse gesture.

The application processor 202 is in communication with the internal memory 204 and is configured to execute applications (e.g., user applications) stored therein. For example, an email application may allow a user of the input computing device 200 to access and view email messages. The application processor 202 provides mobile processing power and functionality to the input computing device. The application processor 202 may execute instructions to perform operations of an application. The application processor 202 may execute and/or implement an input application to enable the input computing device 200 to receive user input that includes or indicates a mouse gesture intended for a receiving computing device, such as the receiving computing device 104 of FIG. 1. The application processor 202 implementing the input application may interpret user input to the input computing device 200 and capture a mouse gesture to communicate to a receiving computing device. The application processor 202 implementing the input application may execute instructions that establish a connection between the input computing device 200 and a receiving computing device. Examples of application processors include, but are not limited to the Apple® application processors (e.g., A6, A7, A8, etc.), Intel® application processors (e.g., Intel® Core™ i7-xxx processors), the Samsung® Exynos processors, ARM® processors, and the like. The application processor 202 may communicate with appropriate peripheral devices (and/or the peripheral device drivers) to present data to a user and/or receive data from the user. Data may be presented to the user via peripherals including but not limited to the speaker 222 and the LCD screen 206. Data may be received through user input via peripherals including but not limited to the touchscreen 206, the keyboard 218, and the microphone 220.

The internal memory 204 may be any computer-readable storage medium, whether volatile or non-volatile, including but not limited to a RAM, an EPROM, a flash drive, an optical drive, or a magnetic hard drive. For example, the internal memory 204 may include a reasonably large amount of storage in the form of volatile SDRAM (1-2 GB) as well as non-volatile compact storage (10+ GB). The internal memory 204 may include an operating system, user applications, and application data. The operating system and user applications may include instructions that, when executed by the application processor 202, cause the application processor 202 to perform operations of an operating system and/or an application and to otherwise implement functions performed by the input computing device 200. The operating system may be fairly traditional, and/or optimized for the applications of the input computing device 200. The applications may include audio/video codec and players, games, image processing, speech processing, internet browsing, text editing, etc. Also, the applications may include an input application, as noted above, which may be included in an input module configured to gather user input to the input computing device 200, including mouse gestures intended to manipulate a mouse pointer or otherwise provide input to a receiving computing device.

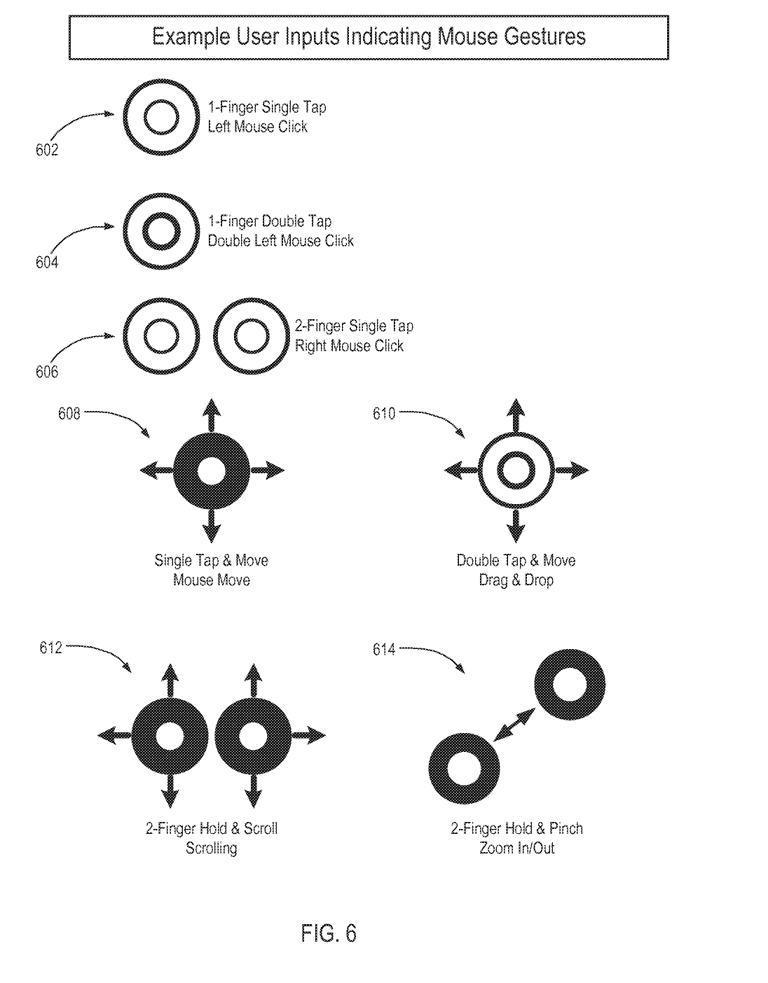

The touchscreen 206 may be utilized by a user to provide input to the input computing device 200. The touchscreen 206 can display content and/or a user interface generated by applications executing on the input computing device 200. The touchscreen 206 also may facilitate user interaction with the input computing device 200, including interaction with user applications executing on the input computing device 200, by enabling a user to provide input via the touchscreen 206. The touchscreen 206 may employ capacitive touchscreen technology, resistive touchscreen technology, or any touchscreen technology traditionally used in computing devices. In some embodiments, an input module of the input computing device includes the touchscreen 206 and receives user input including mouse gestures intended for a receiving computing device. A user can provide mouse gestures intended for a receiving computing device by providing one or more touches or combination of touches via the touchscreen 206. The input module collects the user input provided via the touchscreen 206 and transmits or otherwise communicates to a receiving device the user input and/or the mouse gestures indicated by the user input. Examples of user input via a touchpad to indicate a mouse gesture are shown in FIG. 6 and discussed below in greater detail with reference to the same.

The infrared sensor 208 and/or the camera 210 may be used to detect movement of the input computing device 200 along a flat surface, similar to how a traditional hardware mouse peripheral is moved to provide mouse gestures. An input module of the input computing device 200 may include the infrared sensor 208 and/or the camera 210 to detect movement (e.g., generally two-dimensional movement) of the input computing device 200 as user input indicating a mouse gesture. The detected movement may be interpreted as user input indicating a mouse gesture, which may be communicated to a receiving device. The movement of the input computing device 200 may be subject to a multiple ratio (e.g., 1:2 or greater ratio) to translate the movement to a multiple of that movement on the receiving computing device. Accordingly, in the case of a multiple ratio of 1:2, a movement of the input computing device 200 of a distance d would be translated to movement of a mouse pointer on the receiving device a distance of 2d. The movement of the input computing device 200 detected by the infrared sensor 208 and/or the camera 210 may also facilitate other mouse gestures such as scrolling and dragging.

The one or more accelerometers 212 and/or the gyroscope 214 may detect orientation and/or three-dimensional movement of the input computing device 200. An input module of the input computing device 200 may include the one or more accelerometers 212 and/or the gyroscope 214 to detect changes in orientation and/or three-dimensional movement of the input computing device 200 as user input indicating a mouse gesture. The detected movement may be interpreted as user input indicating a mouse gesture, which may be communicated to a receiving device. The movement of the input computing device 200 may be subject to a multiple ratio (e.g., 1:2 or greater ratio) to translate the movement to a multiple of that movement on the receiving computing device. Accordingly, in the case of a multiple ratio of 1:2, a movement of the input computing device 200 of a distance d would be translated to movement of a mouse pointer on the receiving device a distance of 2d. The movement of the input computing device 200 detected by the one or more accelerometers 212 and/or the gyroscope 214 may also facilitate other mouse gestures such as scrolling and dragging.

The baseband processor 216 of the input computing device 200 is in communication with the internal memory 204 (or may be in communication with separate memory) to provide processing power for interfacing or otherwise communicating with a baseband radio (e.g., a wireless telephone communication network). The baseband processor 216 may implement and/or execute a radio interface, which may include radio interface logic and a radio interface operating system. The baseband processor 216 may be coupled to or otherwise utilize the communication interface 226.

The keyboard 218 may be a physical keyboard (e.g., as provided on a BlackBerry® Q10 or Bold™) or a virtual keyboard provided via the touchscreen 206 (e.g., as provided on an Apple® iPhone®, Samsung® Galaxy®, and most Android-powered devices). The keyboard 218 may be used primarily for providing user input for user applications and may lack involvement in user input indicating mouse gestures. However, in some embodiments, the keyboard 218 may be utilized in user input indicating mouse gestures.

The one or more antennas 224 may be utilized by the communication interface 226 to communicate by one or more wireless communication protocols. The communication interface 226 may include Bluetooth technology and/or Wi-Fi technology to facilitate establishment of communication links with other computing devices, such as the direct communication link 106 with a receiving computing device 104 of FIG. 1. The one or more antennas 224 may be utilized to receive and/or transmit data according to a wireless communication protocol. The communication interface 226 may also utilize the one or more antennas 224 to interface or otherwise communicate with a radio of a wireless telephone communication network, to implement telephone functionality of the input computing device 200.

As can be appreciated, the foregoing components may be included in an input computing device in any combination, and in combination with additional components not described herein.

FIG. 3 is a schematic diagram illustrating a receiving computing device 300, according to one embodiment. The receiving computing device 300 includes an application processor 302, a rendering interface 304 (e.g., liquid crystal display (LCD) screen and/or touchscreen), internal memory 306, a storage medium and/or storage device 308, a network interface 310 including wireless communication interface technology 312 (e.g., Bluetooth, Wi-Fi) and wired communication interface technology 314 (e.g., Cat 5 cable), input/output (I/O) interface 316, and a keyboard 318, all of which may be interconnected, such as via a bus 320. The receiving computing device 300 may be the receiving computing device 104 of FIG. 1. For example, the receiving computing device 300 may be a smartphone, a Tablet, a laptop, a desktop, or a server computing device.

The receiving computing device 300 may be any computing device capable of executing an operating system and/or user applications that may accept mouse gestures. Described differently, the application processor 302 may execute instructions stored in the internal memory 306 and/or the storage medium/device 308 that cause the application processor 302 to perform operations of an operating system and/or an application and to otherwise implement functions performed by the receiving computing device 300. The operating system may be fairly traditional and/or optimized for the applications of the receiving computing device 300. The applications may include audio/video codec and players, games, image processing, speech processing, internet browsing, text editing, and other content consumption applications and content creation applications. Also, the applications of the receiving computing device 300 may include a receiving application, as noted above, which may be included in a receiver module configured to receive from an input computing device a communication of a mouse gesture that was provided to the input computing device. The communication of the mouse gesture may be a communication of the user input provided to the input computing device that includes the mouse gesture. The mouse gesture received by the receiver module is a mouse gesture intended to manipulate a mouse pointer or otherwise provide input to the receiving computing device 300.

A communication of a mouse gesture may be received by the receiving computing device 300 via Bluetooth or Wi-Fi technology 312, or other wireless communication technology, provided via the network interface 310.

The keyboard 318 may offer a user another way to provide input to the receiving computing device 300. The keyboard 318 may be a physical keyboard or a virtual keyboard provided via a touchscreen (e.g., which may be provided as part of the rendering interface 304). The keyboard 318 may be used primarily for providing user input for user applications that execute on the receiving computing device 300.

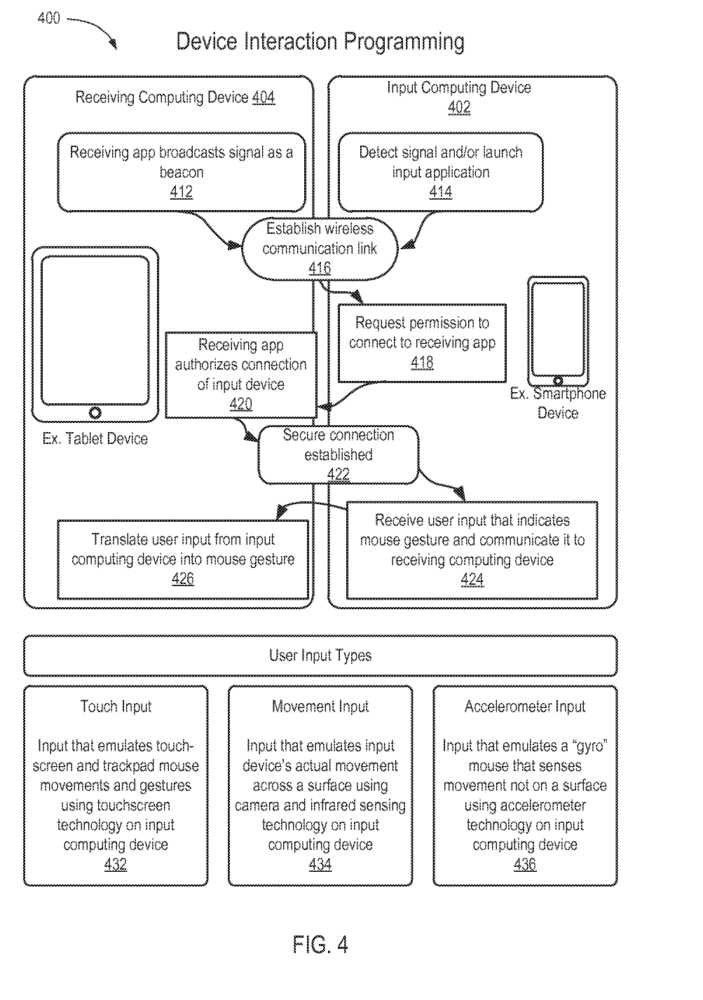

FIG. 4 illustrates an overview of one embodiment of an interaction 400 between an input computing device 402 (e.g., a smartphone) and a receiving computing device 404 (e.g., a Tablet) and a process for establishing a secure Bluetooth or other wireless connection. The input computing device 402 functions as a wireless mouse input remote control for the receiving computing device 404 to provide mouse gestures to the receiving computing device 404.

The receiving computing device 404 may broadcast 412 a wireless signal, such as through Bluetooth wireless technology. When the receiving computing device 404 is broadcasting 412, it may act as a beacon for other devices. The input computing device 402 may detect the broadcast and launch 414 a corresponding input application that receives user input that provides mouse gestures to the receiving computing device 404.

Through a wireless communications stack of both the receiving computing device 404 and the input computing device 402, a wireless communication link is established 416 between the devices 402, 404. The wireless communication link that is established 416 may be a direct link, such as via a direct communication protocol which allows cross-input and data feedback. Once both devices 402, 404 are able to communicate with each other, the input computing device 402 may send a permission request 418 to take control and communicate via a wireless protocol having a security layer to help protect from rogue communications. After the receiving computing device 404 receives such a request, the application, operating system, or user will have the ability to authorize 420 the requested connection of the input computing device 402, and a secure wireless connection may be established 422.

As can be appreciated, in other embodiments, the “handshake” procedure to establish the secure connection may occur in an alternative order. For example, the input computing device 402 may broadcast a wireless signal, thereby functioning as a beacon, and the receiving computing device 404 may detect the signal and launch a corresponding receiving application. Similarly, the receiving computing device 404 may request connection with the input computing device 402, and the input computing device 402 may authorize the request. Also, additional steps may be involved and/or layers of security and/or encryption may be added.

The secure communication that is established 422 allows the input computing device 402 to communicate mouse gestures to the receiving computing device 404. The input computing device 402 may receive a variety of user inputs that can be translated 424 or otherwise interpreted as mouse gestures intended for the receiving computing device 404 (or an application running thereon). The user inputs may be received on the input computing device 402 as touch input 432, movement input 434 (e.g., two-dimensional movement of the device 402, such as on a flat surface), and accelerometer input 436 (e.g., three-dimensional movement of the device 402). In these various ways, the input computing device 402 gathers a variety of user inputs that indicate mouse gestures intended for the receiving computing device 404. The received user inputs can be communicated 424 directly to the receiving computing device 404 over the secure connection.

Upon receiving the user inputs communicated 424 by the input computing device 402, the receiving computing device 404 can translate 426 those inputs into mouse movements, gestures, and touches on the receiving computing device 404 (e.g., within a compatible application layer).

FIG. 4 also provides an illustration representing the multi-input options of the input computing device 402, which may include the following:

Touch Input 432: This type of input generally may be provided via a touchscreen of the input computing device 402 to emulate trackpad mouse movements and gestures. This particular input may use touch and multi-touch input on a touchscreen of the input computing device 402.

Movement Input 434: This type of input may emulate a mechanical (e.g., rollerball) mouse or optical (laser movement) mouse by detecting movements across a flat surface. This particular input may use the camera and infrared technologies of the input computing device 402, for example by focusing a camera on motion movement on a flat surface area.

Accelerometer Input 436: This type of input emulates a mouse that responds to three-dimensional movement. This particular input may use the accelerometer and/or gyroscope movement technology of the input computing device 402.

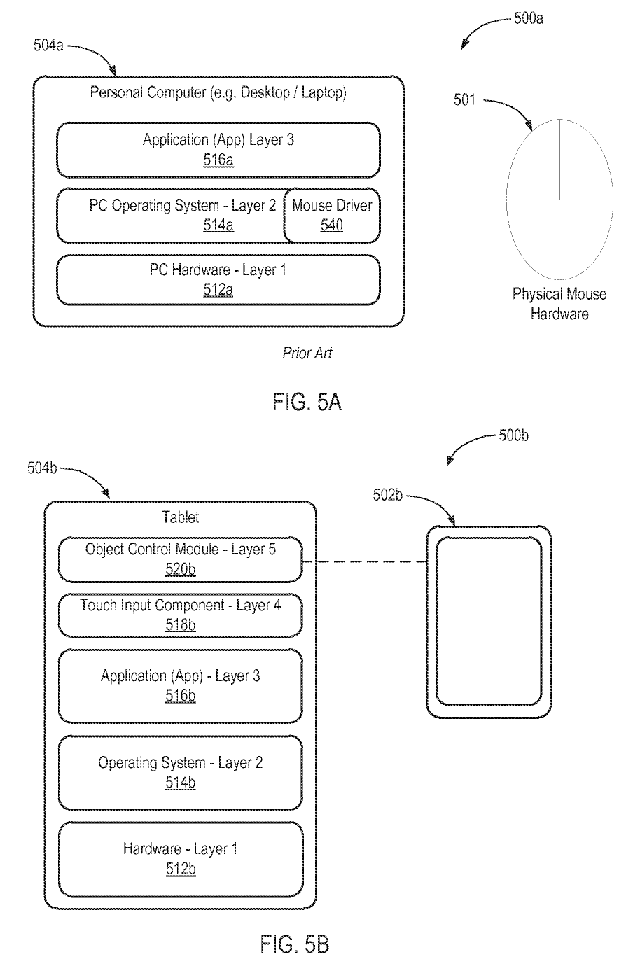

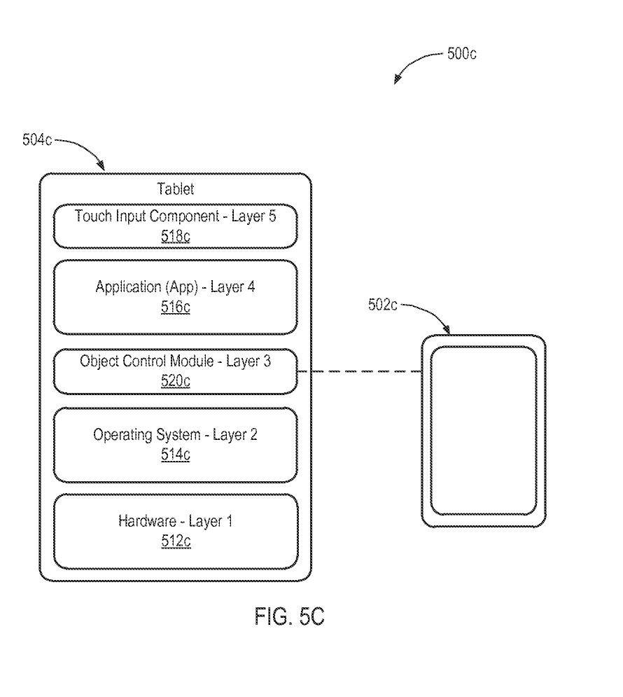

FIG. 5A is a schematic diagram representing an existing system 500a for providing mouse gesture input to a computing device 504a. The computing device 504a is a traditional computing system such as a desktop or laptop personal computer. The computing device 504a includes a PC hardware 512a, a PC operating system 514a, and one or more applications 516a. The operating system 514a interfaces with the hardware 512a of the computing device 504a. The operating system 514a enables implementation and/or execution of applications 516a that are executable on the computing device 504a. The operating system 514a also enable connection and/or interfacing of other hardware peripherals, such as a hardware mouse 501. Specifically, the operating system 514a includes a mouse driver 540 that enables the computing device 504a to communicate with the hardware mouse 501 and/or vice versa. The mouse 501 accesses or otherwise provides input to the mouse driver 540. The mouse driver 540 is traditionally native to the operating system 514a or is installed as an added component of the operating system 514a to interact natively with the operating system functionality. The mouse driver 540 communicates input through the operating system 514a. The operating system 514a dictates how the hardware mouse 501 should function (e.g., present input). The function of the mouse driver 540 is to translate these operating system mandated function calls into device specific calls.

The hardware mouse 501 is a pointing device that detects two-dimensional motion relative to a surface. This motion is typically translated by the mouse driver 540 and/or the operating system 514a into the motion of a pointer on a display of the computing device 504a, which allows for fine control to interact with a graphical user interface, for example of the operating system 514a and/or an application 516a. The mouse 501 includes an object held in a user's hand, with one or more buttons. The mouse 501 may include other elements, such as touch surfaces and “wheels”, which enable additional control and dimensional input. Regardless of the features of the mouse 501, in existing systems 500a, the input provided by the mouse 501 to the computing device 504a occurs through the operating system 514a. The operating system 514a must support input by mouse gestures in order for the mouse to provide any user interaction on the computing device 504a.

Many presently available computing devices, such as Tablets, include operating systems that do not support or even contemplate receiving input by mouse gestures from a mouse. For example, the Apple iOS and the Android operating systems, at the time of the present invention, do not accept or support input via mouse. The various manufacturers of Tablets impose limitations that restrict connection of a dedicated hardware mouse peripheral. As noted above, typically Tablets do not include ports for accepting a hardware mouse. Tablets are typically designed around touch input, via a touch screen, and support interaction only via the touchscreen. There simply is a lack of an input mechanism designed to emulate and simulate a true mouse input experience on a Tablet.

FIG. 5B is a schematic diagram representing a system 500b for providing mouse input to a computing device 504b, according to one embodiment. The computing device 504b is a Tablet. The Tablet 504a includes hardware 512b, an operating system 514b, and one or more applications 516b. The operating system 514b interfaces with the hardware 512b of the Tablet 504b. The operating system 514b manages the hardware 512b resources and other resources and provides common services for the applications 516b. The operating system 514b enables implementation and/or execution of the applications 516b that are executable on the Tablet 504b. The Tablet 504b may be an Apple iPad and the operating system 514b may be an Apple iOS operating system.

The operating system 514b (or a main kernel thereof) may expressly limit or even prevent connection and/or interfacing of other hardware peripherals, such as a hardware mouse. Specifically, the operating system 514b lacks a mouse driver or any functionality that would enable the computing device 504b to communicate with a hardware mouse. The Tablet may lack ports to accept a connection with a hardware mouse.

The Tablet 504b also includes a touch input component 518b and an object control module 520b. The touch input component 518b may be a user interface framework extension of the operating system 514b, such as the Cocoa Touch Layer in iOS. Described differently, the touch input component 518b may provide an abstraction layer that implements graphical user interface control elements. In particular, the touch input component 518b may enable interfacing with the Tablet 504b via touchscreen input. The touch input component 518b enables handling of touch-based and motion-based events.

The object control module 520b may be a receiver module that is configured to receive input communicated from an input computing device 502b. The received input indicates a mouse gesture intended for the Tablet 504b. The object control module 520b may translate or otherwise interpret the input to determine the mouse gesture intended for the Tablet 504b. The mouse gesture is interpreted by the object control module 520b, for example, to determine an action that should be performed to interact with an application 516b on the Tablet 504b.

The object control module 520b may, based on the received input and/or mouse gesture, emulate touchscreen input. The emulated touchscreen input may be communicated to the touch input component 518b to interface with application 516b to effectuate the mouse gesture and/or the intended action. In other words, the object control module 520b provides an overlay to communicate remotely generated mouse gestures to the touch input component 518b and/or the application 516b. The object control module 520b receives input from the input computing device 502b and effectuates a mouse gesture and/or an intended action of a mouse gesture within an active application 516b through the touch input component 518b. The object control module 520b communicates directly with the touch input component 518b to enable control of inputs to the touch input component 518b of the Tablet 504b from the remote input computing device 502b.

The operating system 514b is unaware of the object control module 520b. The object control module 520b executes and/or operates separate from operating system 514b functionality. The object control module 520b may interface solely with the touch input component 518b. Rather than the Tablet 504b being controlled by touch, gesture, or accelerator input directly, the object control module 520b allows interactivity with the Tablet 504b from a remote input computing device 502b. The object control module 520b creates the ability for a remotely connected input computing device to simulate direct interactivity with the Tablet's touch input component 518b in a virtual fashion.

FIG. 5C is a schematic diagram representing a system 500c for providing mouse input to a computing device 504b, according to another embodiment. The computing device 504c is a Tablet. The Tablet 504c includes hardware 512c, an operating system 514c, and one or more applications 516c. The operating system 514c interfaces with the hardware 512c of the Tablet 504c. The operating system 514c enables implementation and/or execution of the applications 516c that are executable on the Tablet 504c. The operating system 514c may be an Android operating system, which may enable limited interfacing with external hardware.

The operating system 514c may expressly limit connectivity with and/or interfacing of other hardware peripherals, such as a hardware mouse. Specifically, the operating system may 514c lack a mouse driver and/or any native functionality that would enable the computing device 504c to communicate with a hardware mouse. The Tablet 504c may lack ports to accept a connection with a hardware mouse. In other embodiments, the operating system 514c may allow connectivity and/or interfacing with hardware peripherals, such as a mouse, but may lack functionality for accepting mouse gestures as input to interact with the applications 516c.

The Tablet 504c also includes a touch input component 518c and an object control module 520c. As described above, the touch input component 518c may be a user interface framework extension of the operating system 514c, such as an abstraction layer of the Android operating system that implements graphical user interface control elements. The touch input component 518c may enable interfacing with the Tablet 504c via touchscreen input by enabling handling of touch-based and motion-based events.

The object control module 520c may be a receiver module that is configured to receive input communicated from an input computing device 502c. The received input indicates a mouse gesture intended for the Tablet 504c. The object control module 520c may translate or otherwise interpret the input to determine the mouse gesture intended for the Tablet 504c. The mouse gesture is interpreted by the object control module 520c, for example, to determine an action that should be performed to interact with an application 516c on the Tablet 504c.

The object control module 520b may, based on the received input and/or mouse gesture, emulate touchscreen input. The emulated touchscreen input may be communicated to the touch input component 518c to interface with application 516c to effectuate the mouse gesture and/or the intended action. In other words, the object control module 520c provides an overlay to communicate remotely generated mouse gestures to the touch input component 518c and/or the application 516c. The object control module 520c receives input from the input computing device 502c and effectuates a mouse gesture and/or an intended action of a mouse gesture within an active application 516c through the touch input component 518c. The object control module 520c communicates directly with the touch input component 518c to enable control of inputs to the touch input component 518c of the Tablet 504c from the remote input computing device 502c.

The object control module 520c of FIG. 5C may interface with the operating system 514c to enable receipt of input and/or to enable communication of mouse gestures to the touch input component 518c in a more general fashion, system-wide rather an to individual applications. Nevertheless, the object control module 520b interfaces with the touch input component 518c to effectuate mouse gestures within the application 514c. The object control module 520c emulates touchscreen input, gestures, or accelerometer input to interface applications through the touch input component 518c. Rather than the Tablet 504c being controlled by touch, gesture, or accelerator input directly, the object control module 520c allows interactivity with the Tablet 504c from a remote input computing device 502c. The object control module 520c creates the ability for a remotely connected input computing device to simulate direct interactivity with the Tablet's touch input component 518c in a virtual fashion.

In the embodiments of FIGS. 5B and 5C, the mouse gestures are provided to the object input component 520b, 520c, which emulates touch input, gestures, and accelerometer input to the touch input component 518b, 518c to effectuate the mouse gestures within the applications 516b, 516c. The mouse gestures are not presented through the operating system.

FIG. 6 illustrates example user inputs indicating mouse gestures used for an embodiment of the present disclosure that includes a touchpad. These user inputs may be provided to the input computing device via a touchscreen of the input computing device. The user input options emulate a trackpad mouse peripheral and include the following gesture/touch inputs: A 1-Finger Single Tap 602 on the touchscreen of the input computing device results in a Left Mouse Click on the receiving computing device. A 1-Finger Double Tap 604 on the touchscreen of the input computing device results in a Double Left Mouse Click on the receiving computing device. A 2-Finger Single Tap 606 on the touchscreen of the input computing device results in a Right Mouse Click on the receiving computing device. A 1-Finger Single Tap and Move 608 up, down, left, right, or angled on the touchscreen of the input computing device results in a corresponding mouse pointer movement on the receiving computing device. A 1-Finger Double Tap and Move 610 on the touchscreen of the input computing device results in a Drag and Drop on the receiving computing device. A 2-Finger Hold and Scroll 612 up, down, left, right, or angled on the touchscreen of the input computing device results in scrolling in a corresponding direction on the receiving computing device. A 2-Finger Hold and Pinch 614 on the touchscreen of the input computing device results in a Zoom In or Zoom Out of the view on the receiving computing device display screen.

These aforementioned touchscreen input combinations provide illustrative examples of how common mouse gestures may be indicated through user input employing a touchscreen of the input computing device. Additional user input indicating mouse gestures may be provided to the input computing device using other technologies of the input computing device, including accelerometer technology and actual device movement technology (e.g., on a flat surface). The touch user input illustrated in FIG. 6 may be used in combination with these other technologies (added actual mouse movement input) to indicate desired mouse gestures.

Device movement technology using an infrared sensor and/or camera may detect movement of the input computing device on a flat surface—forward, backward, left, right, and angled—to create the corresponding mouse pointer movements on the receiving computing device.

User input via the accelerometer technology may be provided to the input computing device by tilting the device up, down, left, right, and angled to create the corresponding mouse movements on the receiving computing device. Certain input computing devices may allow a user to generate motion events when they move, shake, or tilt the input computing device. These motion events may be detected by device hardware, such as an accelerometer and/or a gyroscope. The input computing device may include three accelerometers, one for each axis: x, y, and z. Each accelerometer measures changes in velocity over time along a linear path. Combining all three accelerometers allows detection of device movement in any direction and determining the device's current orientation. Although there may be three accelerometers, the remainder of this document refers to them as a single accelerometer. The gyroscope measures the rate of rotation around the three axes. The accelerometer and gyroscope motion events may originate from the same hardware.

On Apple devices, for example, there may be several different ways the accelerometer and/or gyroscope hardware data can be accessed, depending on needs, such as the following:

General orientation of a device, without knowing the orientation vector, can be detected using a UIDevice class as explained in the Apple developer library under the topic “Getting the Current Device Orientation with UIDevice.”

Detecting when a user shakes the device can be accomplished using the UIKit motion-event handling methods to get information from the passed-in UIEvent object, as explained in the Apple developer library under the topic “Detecting Shake-Motion Events with UIEvent.”

If neither the UlDevice nor the UlEvent classes are sufficient, the Core Motion framework may be used to access the accelerometer, gyroscope, and device motion classes, as explained in the Apple developer library under the topic “Capturing Device Movement with Core Motion.”

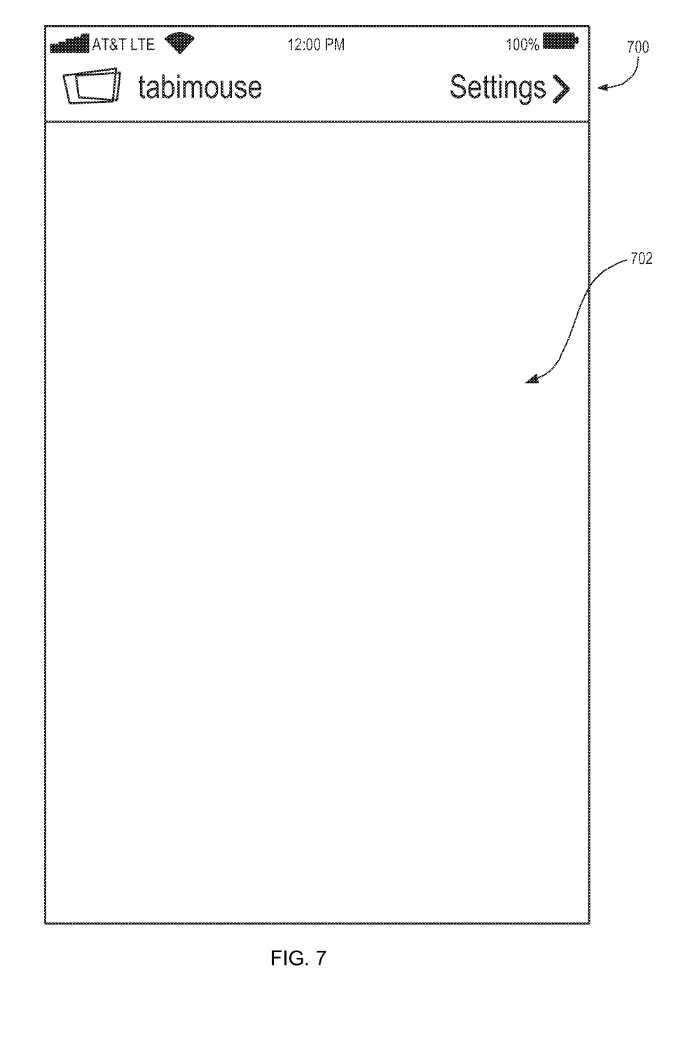

FIG. 7 illustrates a touchpad version user interface 700 for an input application on a smartphone input computing device, according to one embodiment. FIG. 7 illustrates the user interface 700 providing an area of input 702 where a user may provide touch input on the input computing device. When a user's fingers touch the area of input 702 of the user interface 700, a green circle may show feedback and follow the input locations of the user's fingers, whether one finger or multiple fingers.

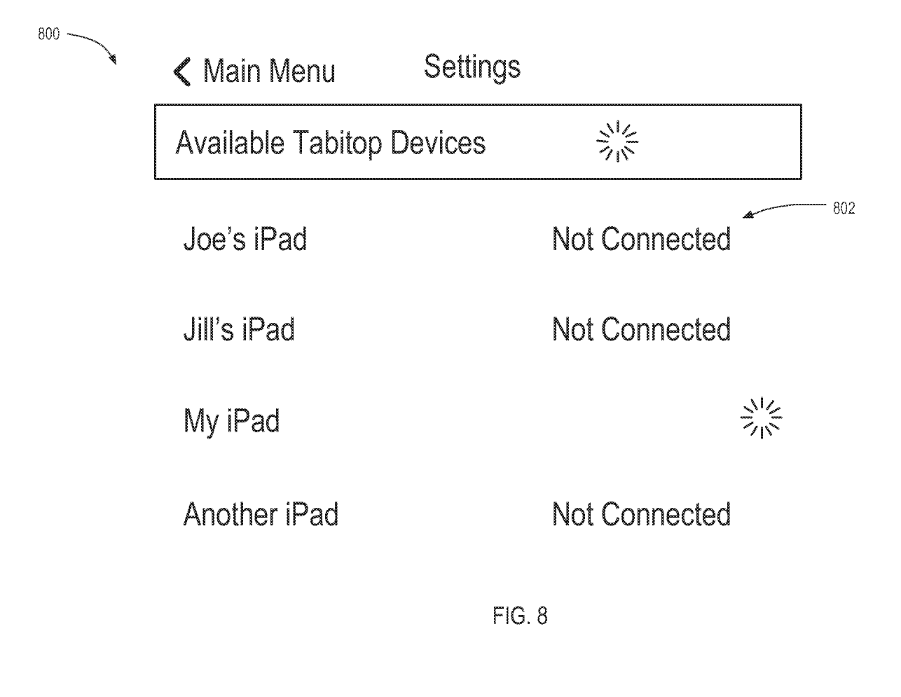

FIG. 8 illustrates a user interface of an input computing device presenting a settings screen 800 used to find and connect to a receiving computing device. The settings screen 800 of the user interface of the input device may also include the option to view a listing 802 of available receiving devices, such as other Tablets currently running a compatible receiving application, and allows the user to connect to a specific receiving device of choice. A connection security process and protocol require that the receiving device grant permission prior to successful connection.

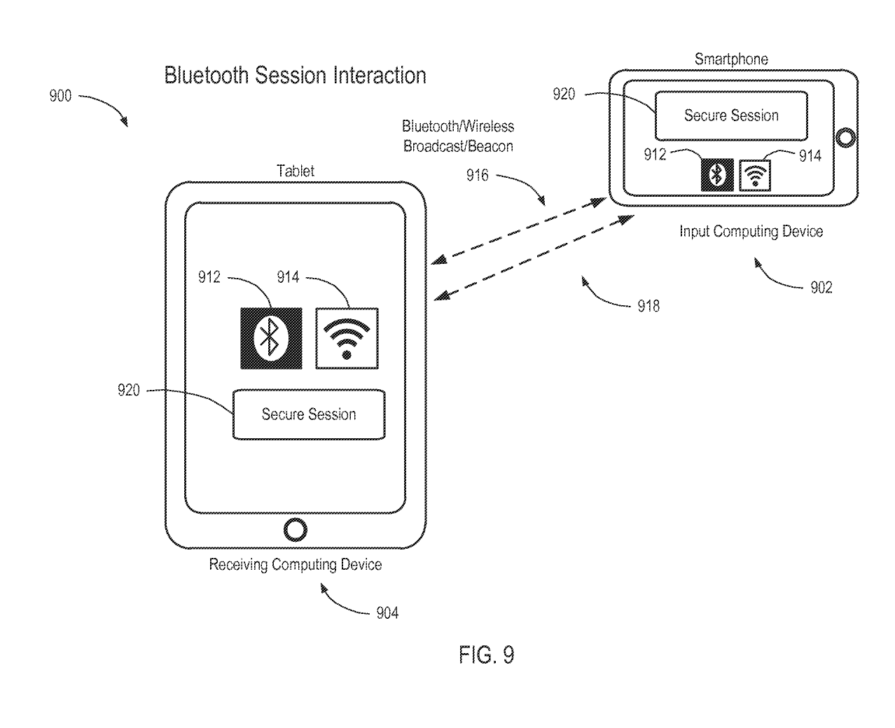

FIG. 9 illustrates a wireless session interaction 900 between an input computing device 902 and a receiving computing device 904, according to one embodiment. The process for connecting the input computing device 902 and the receiving computing device 904 may be predicated on how both the receiving computing device 904 and the input computing device 902 interact and communicate with each other. The receiving computing device 904 may start a Bluetooth 912 or Wi-Fi 914 broadcast session, broadcasting a communication signal 916 and in essence functioning as a beacon for potential input computing devices, such as the input computing device 902.

In response to the outgoing communications signal 916, the input computing device 902 may see the available receiving computing device 904 via Bluetooth 913 or Wi-Fi 914, and attempt to provide a communication signal 916 back to the receiving computing device 904, at which point security protocol is exchanged 918 and the receiving computing device 904 may create a secure wireless session 920 with the input computing device 902, which joins the newly created secure session 920 and can then relay user input to receiving computing device 904, emulating the specific inputs of mouse gestures.

In one embodiment, the Apple® iOS (or other operating system) handles low-level Bluetooth stack or Wi-Fi intercepting. A high-level framework may be provided that handles the invitation and communication between the two apps (e.g., MultipeerConnectivityFramework). This framework may use (1) infrastructure Wi-Fi networks; (2) peer-to-peer Wi-Fi; and (3) Bluetooth personal area networks.

In other embodiments, with other mobile operating platforms, a library may be implemented which comprises Bluetooth monitoring and uses Wi-Fi Direct. The framework may allow the app to set up a unique identifier for the user (e.g., the device name may be used to generate a special peer ID). After that unique identifier is created, a session may be created for the framework to use. Instruction are given for the framework to broadcast on the receiving device and to browse on the input device. The framework may allow various types of services to be provided (e.g., by transmission), including: (1) sending message-based data; (2) streaming data; and (3) transmitting resources (i.e., files).

In one embodiment, the delta data (new/changed data) may be sent over as message-based data. The delta data may be calculated by obtaining the coordinate of when the user starts to pan and then subtracting it from the new point when the user starts moving. This continues looping, with the start point being swapped out for the previous point until the user lifts his or her finger. The delta data is then applied to the coordinate where the mouse pointer on the receiving computing device is located. The movement may be typically a 1:2 or greater ratio, meaning that when a user moves one pixel on the input computing device, the receiving computing device moves the mouse pointer two or more pixels.

In a case of tapping, the input device may send a string to tell the receiving device to tap at the mouse location. The string may also specify what type of mouse click has happened, such as single click, double click, etc. For example, the MultipeerConnectivityFramework provided by the Apple® iOS on a receiving device may be configured to use MCAdvertiserAssistant when the app loads. MCAdvertiserAssistant is a class that handles broadcasting to tell another device that it is available for use. The class takes a unique key string, which is used to distinguish a broadcast so another app cannot find the broadcaster unless given the same string. This class also allows the app to show a confirmation screen if a user has connected.

MultipeerConnectivityFramework may be configured on an Apple® iOS input computing device using MCNearbyServiceBrowser class. The way this class is configured is the same as MCAdvertiserAssistant, so it takes a peer ID session and a unique key string. When browsing, the input application may look for devices broadcasting the unique ID that was passed. This class may be used when the user wants to connect to a receiving computing device.

MultipeerConnectivityFramework may allow for a plurality of devices (e.g., up to eight) to connect to a single device. However, the disclosed embodiments may limit connections to one device. This MultipeerConnectivityFramework may also handle a security handshake between the two apps.

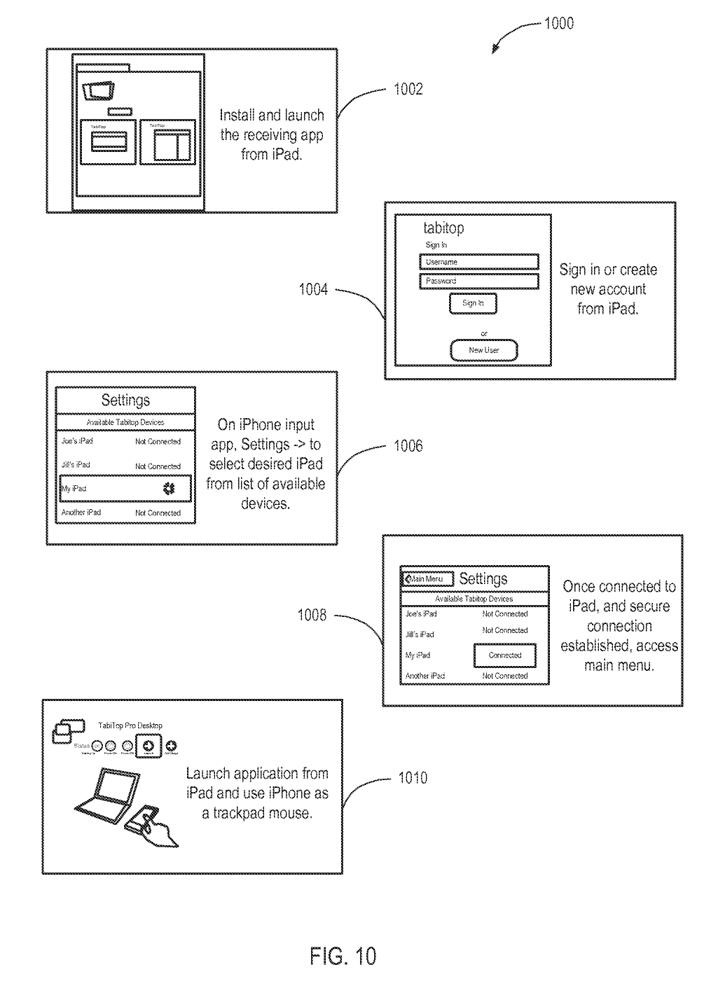

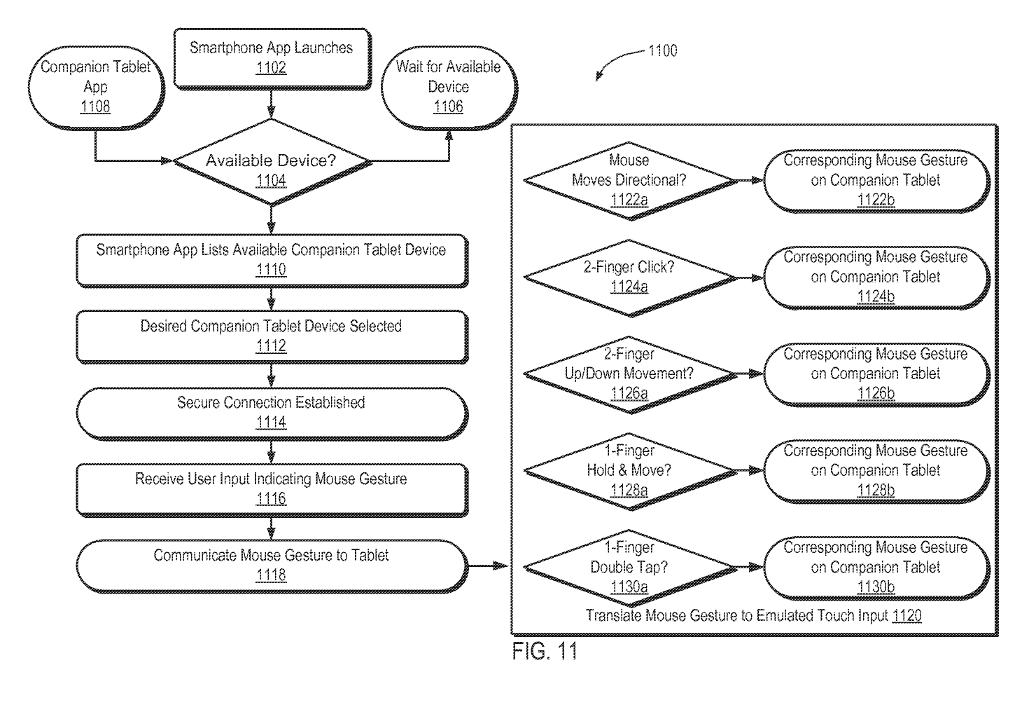

FIG. 10 illustrates user interfaces at various stages of a process 1000 of an iPhone® input computing device connecting to an iPad® receiving computing device, according to one embodiment (referred to in the drawings as “tabitop”). A receiving application may be installed and/or launched 1002 on an iPad® receiving computing device. A user may then be able to create or sign-in 1004 to an account, such as for a subscription-based service, and then launch 1006 a compatible mobile input application on the iPhone input computing device. A secure connection is then established 1008 between the iPad and iPhone, and a user is able to use 1010 the iPhone input device as a fully functional trackpad wireless mouse to provide input to the iPad receiving device.

As can be appreciated, in other embodiments, a handshake process between the iPad and iPhone may occur differently. For example, the iPhone may be selected as an input computing device from a receiving application of the iPad and the iPad may initiate establishment of the secure connection.

FIG. 11 is a flow diagram of a method 1100 of providing input via a first computing device (an input computing device) to a second computing device (a receiving computing device), according to one embodiment. FIG. 11 illustrates logic that may enable using an input computing device to provide mouse gestures as input to a receiving computing device. An application is launched 1102 on the input computing device. The application determines 1104 if there are any available receiving computing devices. If no device is found, the application simply does not give an option to connect to another device and waits 1106 until a compatible device becomes available. However, if a companion receiving device application is launched 1108 or otherwise already available on one or more receiving computing devices, then the input computing device lists 1110 the available receiving computing device(s) on the settings screen 800 (see FIG. 8). Once a desired companion receiving device is selected 1112, a secure connection may be established 1114, for example via Bluetooth, Wi-Fi, or similar wireless connection. User input indicating a mouse gesture then is able to be received 1116 (e.g., movement, gestures, etc.) on the input computing device. The user input and/or mouse gesture is communicated 1118 to the receiving computing device and, once received, translated 1120 into corresponding mouse movements on the associated and connected receiving computing device. Translation 1120 of the mouse gesture may include emulating touch input to provide to a touch input component layer of the receiving computing device to effectuate the action intended by the mouse gesture.

The mouse gestures may include, but are not limited to, Mouse Movement 1122a, 1122b; 2-Finger Click 1124a, 1124b; 2-Finger Up/Down Movement 1126a, 1126b; 1-Finger Hold and Move 1128a, 1128b; and 1-Finger Double Tap 1130a, 1130b. A determination 1122a, 1124a, 1126a, 1128a, 1130a is made as to what action is intended or what mouse gesture is provided, and a corresponding action is performed 1122b, 1124b, 1126b, 1128b, 1130b or otherwise effected on the receiving computing device.

In the illustrated embodiment, the translation 1120 of the mouse gesture occurs on the receiving computing device. However, as can be appreciated, in other embodiments a translation of the mouse gesture may occur on the input computing device prior to communication to the receiving computing device.

Example embodiments may include the following:

### Example 1

A Portable Computing Device for Providing Input to Another computing device, the portable computing device comprising: an application processor to execute user interactive applications; a memory in communication with the application processor, the memory comprising one or more applications that are executable by the application processor; an input module to receive user input to the portable computing device that indicates a mouse gesture, the mouse gesture interpretable by a receiving computing device to perform an action within an application on the receiving computing device; and a wireless communication interface to communicate received user input to the receiving computing device.

### Example 2

The portable computing device of Example 1, wherein the input module further comprises a touchscreen display to receive the user input as one or more touch gestures.

### Example 3

The portable computing device of Example 2, wherein the touchscreen display is configured to present a user interface generated by user interactive applications executed by the application processor of the portable computing device.

### Example 4

The portable computing device of Example 1, wherein the input module further comprises one or more of a camera and an infrared sensor to receive the user input as surface movement of the portable computing device along a flat surface.

### Example 5

The portable computing device of Example 1, wherein the input module further comprises one or more accelerometers to receive the user input as multi-dimensional movement of the portable computing device.

### Example 6

The portable computing device of Example 1, wherein the wireless communication interface comprises Bluetooth® technology.

### Example 7

The portable computing device of claim 1, further comprising a transmitter-receiver configured to communicate with a wireless telephone communication network, wherein the portable computing device comprises a mobile smartphone.

### Example 8

The portable computing device of Example 7, further comprising a baseband processor to execute operations that enable communication with the wireless telephone communication network.

### Example 9

The portable computing device of Example 1, wherein the mouse gesture is presentable on a display screen of the receiving computing device as a movement of a mouse pointer.

### Example 10

The portable computing device of Example 9, wherein the action, when performed by the receiving computing device, is presented on the display screen of the receiving computing device.

### Example 11

A method for providing input to another computing device, comprising: establishing a wireless communication connection between an input computing device and a receiving computing device; receiving on the input computing device user input that indicates a mouse gesture intended for the receiving computing device, the mouse gesture interpretable by the receiving computing device to perform an action within an application on the receiving computing device; and transmitting the mouse gesture from the input computing device to the receiving computing device.

### Example 12

The method of Example 11, wherein receiving the user input comprises receiving the user input via a touchscreen display as touch gestures.

### Example 13

The method of Example 12, wherein the touchscreen display is configured to present a user interface generated by user interactive applications executed by an application processor of the input computing device.

### Example 14

The method of Example 12, further comprising: executing a user application on an application processor of the input computing device; and presenting, on the touchscreen, a user interface generated by the user application.

### Example 15

The method of Example 11, wherein receiving the user input comprises detecting surface movement of the input computing device along a flat surface using one or more of a camera and an infrared sensor.

### Example 16

The method of Example 11, wherein receiving the user input comprises detecting multi-dimensional movement of the input computing device using one or more accelerometers of the input computing device.

### Example 17

The method of Example 11, wherein transmitting the mouse gesture comprises transmitting via Bluetooth technology.

### Example 18

The method of Example 11, further comprising establishing a communication link between the input computing device and a wireless telephone communication network.

### Example 19

The method of Example 11, wherein transmitting the mouse gesture to the receiving computing device includes transmitting the user input that indicates the mouse gesture.

### Example 20

A computer-readable storage medium having stored thereon instructions that, when executed by one or more computing devices, cause the one or more computing devices to perform operations comprising: establishing a wireless communication connection between an input computing device and a receiving computing device; receiving on the input computing device user input that indicates a mouse gesture intended for the receiving computing device, the mouse gesture interpretable by the receiving computing device to perform an action within an application on the receiving computing device; and transmitting the mouse gesture from the input computing device to the receiving computing device.

### Example 21

A computing device manipulatable by mouse gestures from a portable computing device, the computing device comprising: an application processor; a memory in communication with the application processor, the memory comprising one or more applications that are executable by the application processor, wherein an application of the one or more applications is configured to provide a user interface during execution of the application by the application processor, the user interface configured to enable user interaction using mouse gestures; a display configured to present the user interface of the application; a receiver module to receive an input indicating a mouse gesture intended to perform an action within the application on the computing device during execution of the application by the application processor; and a wireless communication interface to receive from a portable computing device the input indicating the mouse gesture, wherein the portable computing device includes an application processor and is configured to execute user interactive applications.

### Example 22

The computing device of Example 21, wherein the input received by the receiver module comprises user input provided to the portable computing device as touch gestures via a touchscreen.

### Example 23

The computing device of Example 21, wherein the input received by the receiver module comprises user input provided to the portable computing device as surface movement of the portable computing device along a flat surface.

### Example 24

The computing device of Example 21, wherein the input received by the receiver module comprises user input provided to the portable computing device as multi-dimensional movement of the portable computing device.

### Example 25

The computing device of Example 21, wherein the mouse gesture is presentable on the display as a movement of a mouse pointer.

### Example 26

The computing device of Example 21, wherein the action, when performed within the application on the computing device, is presentable on the display.

### Example 27

The computing device of Example 21, wherein the portable computing device comprises a mobile smartphone that is connectable with a wireless telephone communication network, and wherein the wireless communication interface receives the input from the mobile smartphone via a wireless communication interface distinct from an interface with the wireless telephone communication network.

### Example 28

A portable computing device for providing mouse gestures to another computing device, the portable computing device comprising: a processor; a memory in communication with the processor, the memory comprising one or more applications that are executable by the processor; an input module to receive user inputs that indicate a mouse gesture that is intended to perform an action within an application on a receiving computing device; and a wireless communication interface to communicate received user inputs to the receiving computing device.

### Example 29

A computing device manipulatable by mouse gestures from a portable computing device, the computing device comprising: an application processor; a memory in communication with the application processor, one or more applications stored in the memory that are executable by the application processor, wherein an application of the one or more applications is configured to provide a user interface during execution of the application by the application processor, the user interface configured to enable user interaction using mouse gestures; an operating system providing functionality to enable the application processor to execute applications; a touchscreen display configured to present the user interface of the application, to receive touch input from the user, and to communicate the touch input to the touch input component; a touch input component to interface with and extend functionality of the operating system and overlay an executing application of the plurality of applications to communicate touch input to the executing application; a wireless communication interface to receive, from a remote portable input computing device, input indicating a mouse gesture intended to perform an action within the application on the computing device during execution of the application by the application processor, wherein the portable computing device includes an application processor and is configured to execute user interactive applications; and a receiver module to receive from the wireless communication interface the input indicating a mouse gesture, generate emulated touchscreen input, and communicate the emulated touchscreen input to the touch input component to effectuate the intended action within the application on the computing device.

### Example 30

The computing device of Example 29, wherein the receiver module communicates directly with the touch input component to enable control of inputs to the touch input component of the computing device from the remote portable input computing device, without interaction with the operating system.

### Example 31

The computing device of Example 29, wherein one of the computing device and the operating system of the computing device limits connection of a hardware mouse to the operating system.

### Example 32

The computing device of Example 29, wherein one of the computing device and the operating system of the computing device prevents connection of a hardware mouse to the operating system.

### Example 33

A method for providing input to another computing device, comprising: establishing a wireless communication connection between an input computing device and a receiving computing device; receiving from the input computing device, via a wireless communication interface, user input that indicates a mouse gesture intended for the receiving computing device, the mouse gesture intended to perform an action within an application on the receiving computing device; generating, by a receiver module on the receiving computing device, emulated touch input to effectuate the mouse gesture intended to perform the action within the application; and providing the emulated touch input to a touch input component of the receiving computing device, the touch input component implementing graphical user interface control elements to handle touch-based events on the receiving computing device.

### Example 34

The method of Example 33, further comprising: handling by the touch input component on the receiving computing device the emulated touch input to perform the action intended by the mouse gesture in the application on the receiving computing device.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smartphone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a non-transitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single module or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

As will be appreciated by those having skill in the art, many changes may be made to the details of the above-described embodiments without departing from the underlying principles of the invention. The scope of the present invention should, therefore, be determined only by the following claims.

What is claimed is:

1. A portable computing device for providing input to another computing device, the portable computing device comprising:
an application processor to execute user interactive applications;
a memory in communication with the application processor, the memory comprising one or more applications that are executable by the application processor;
an input module to receive user input to the portable computing device that indicates a mouse gesture, the mouse gesture interpretable by a receiver module of a receiving computing device to emulate touch input on the receiving computing device to perform an action within an application on the receiving computing device; and
a wireless communication interface to communicate received user input to the receiving computing device.

2. The portable computing device of claim 1, wherein the input module further comprises a touchscreen display to receive the user input as one or more touch gestures.

3. The portable computing device of claim 2, wherein the touchscreen display is configured to present a user interface generated by user interactive applications executed by the application processor of the portable computing device.

4. The portable computing device of claim 1, wherein the input module further comprises one or more of a camera and an infrared sensor to receive the user input as surface movement of the portable computing device along a flat surface.

5. The portable computing device of claim 1, wherein the input module further comprises one or more accelerometers to receive the user input as multi-dimensional movement of the portable computing device.

6. The portable computing device of claim 1, wherein the wireless communication interface comprises Bluetooth® technology.

7. The portable computing device of claim 1, further comprising a transmitter-receiver configured to communicate with a wireless telephone communication network.

8. The portable computing device of claim 7, further comprising a baseband processor to execute operations that enable communication with the wireless telephone communication network.

9. The portable computing device of claim 1, wherein the mouse gesture is presentable on a display screen of the receiving computing device as a movement of a mouse pointer.

10. The portable computing device of claim 9, wherein the action, when performed by the receiving computing device, is presented on the display screen of the receiving computing device.

11. A method for providing input to another computing device, comprising:
establishing a wireless communication connection between an input computing device and a receiving computing device;
receiving on the input computing device user input that indicates a mouse gesture intended for the receiving computing device, the mouse gesture interpretable by the receiving computing device to perform an action within an application on the receiving computing device; and
transmitting the mouse gesture from the input computing device to the receiving computing device.

12. The method of claim 11, wherein receiving the user input comprises receiving the user input via a touchscreen display as touch gestures.

13. The method of claim 12, wherein the touchscreen display is configured to present a user interface generated by user interactive applications executed by an application processor of the input computing device.

14. The method of claim 12, further comprising:
executing a user application on an application processor of the input computing device; and
presenting, on the touchscreen, a user interface generated by the user application.

15. The method of claim 11, wherein receiving the user input comprises detecting surface movement of the input computing device along a flat surface using one or more of a camera and an infrared sensor.

16. The method of claim 11, wherein receiving the user input comprises detecting multi-dimensional movement of the input computing device using one or more accelerometers of the input computing device.

17. The method of claim 11, wherein transmitting the mouse gesture comprises transmitting via Bluetooth technology.

18. The method of claim 11, further comprising establishing a communication link between the input computing device and a wireless telephone communication network.

19. The method of claim 11, wherein transmitting the mouse gesture to the receiving computing device includes transmitting the user input that indicates the mouse gesture.

20. A computer-readable storage medium having stored thereon instructions that, when executed by one or more computing devices, cause the one or more computing devices to perform operations comprising:
establishing a wireless communication connection between an input computing device and a receiving computing device;
receiving on the input computing device user input that indicates a mouse gesture intended for the receiving computing device, the mouse gesture interpretable to perform an action to interface with an application on the receiving computing device; and
transmitting the mouse gesture from the input computing device to the receiving computing device.
